(19) United States
(12) Patent Application Publication
(10) Pub. No.: US 2025/0112563 A1
(43) Pub. Date: Apr. 3, 2025

(54) Multi Drive-Mode Actuators

(71) Applicant: Acuvi AB, Uppsala (SE)

(72) Inventor: Andreas DANELL, Vattholma (SE)

(21) Appl. No.: 18/728,519

(22) PCT Filed: Jan. 12, 2023
(86) PCT No.: PCT/SE2023/050032

§ 371 Date: Jul. 12, 2024

(30) Foreign Application Priority Data
Jan. 13, 2022 (SE) 2250017-7

(51) Int. Cl. H02N 2/00

(52) U.S. Cl. CPC H02N 2/008; H02N 2/0015

(57) ABSTRACT

An electromechanical actuator comprises a volume comprising electromechanically active material, a set of electrodes and a single drive pad. The single drive pad protrudes in a direction parallel to the third axis. The volume of electromechanically active material has a first and second part volume situated at a first longitudinal side, along the first axis, and a third and fourth part volume are situated at a second opposite longitudinal side. The first and third part volumes are situated at a first transverse side and the second and fourth part volumes are situated oppositely. The set of electrodes is provided for allowing excitation of the part volumes independently of each other. A motor comprising such an actuator is also disclosed as well as methods for driving the actuator and motor.

### TECHNICAL FIELD

The present technology refers in general to electromechanical actuators and in particular to electromechanical actuators and electromechanical motors driven by the action of electromechanically active material and methods for driving the electromechanical actuators and electromechanical motors.

### BACKGROUND

Actuators driven by the action of shape changes of electromechanical elements have been used for a while, in particular for use in small motors and/or where fine positioning is of importance. Non-exclusive examples of electromechanically active materials are piezoelectric materials and electrostrictive materials.

The general concept of this type of motors is that an actuator comprising electromechanically active material is arranged to act against a driving surface of a body to be moved. The electromechanically active material causes small shape and/or dimension changes when activated, and this movement is transferred to a relative motion between the actuator and the body to be moved. Typically, one or a plurality of contact points between the actuator and the body to be moved are used for achieving the interaction. The applied relative motion may typically be a linear movement and/or a circular movement, but other movement paths are also possible. Typical examples of such electromechanical actuators may be found in e.g. the published international patent applications WO 2019/035757 A1 and WO 2019/045630 A1.

In a simple setup, the relative movement is, however, typically one-dimensional. If a motion in more than one linear or rotational direction is to be achieved, the typical solution is based on a serial connection of actuators, where one actuator is used as a body to be moved for another actuator. Each actuator is thus responsible for one motion direction. A drawback of such solutions is that the geometrical size of the combined actuators often becomes relatively large. Since this type of motors often is required to be fit into very tine volumes, there might be sincere problems.

### SUMMARY

A general object of the present technology is to find other approaches to achieve multi-directional actuator arrangements, requiring less space.

The above object is achieved by methods and devices according to the independent claims. Preferred embodiments are defined in dependent claims.

In general words, in a first aspect, an electromechanical actuator comprises a volume comprising electromechanically active material, a set of electrodes and a single drive pad. The volume comprising electromechanically active material has a general rectangular cuboid shape with a first, main, axis that is longer than a second and third axis, mutually perpendicular and both perpendicular to the first axis. The set of electrodes is arranged for exciting the volume of electromechanically active material by means of electrical signals. The single drive pad protrudes from the volume of electromechanically active material in a direction parallel to the third axis. The volume of electromechanically active material has a first and second part volume situated at a first longitudinal side, along the first axis, with respect to the single drive pad and a third and fourth part volume situated at a second longitudinal side, opposite to the first longitudinal side, along the first axis, with respect to the single drive pad. The first and third part volumes are situated at a first transverse side, along the second axis, with respect to the single drive pad. The second and fourth part volumes are situated at a second transverse side, opposite to the first transverse side, along the second axis, with respect to the single drive pad.

The set of electrodes is provided for allowing excitation of the first, second, third and fourth part volumes independently of each other.

In a second aspect, an electromechanical motor comprises a first electromechanical actuator according to the first aspect, a body to be moved and normal-force providing means. The body to be moved is arranged with a drive surface of the body to be moved against the single drive pad. The normal-force providing means is configured for applying a normal force between the single drive pad and the body to be moved in a direction of the third axis.

In a third aspect, a method for driving an electromechanical actuator comprises exciting of a volume of electromechanically active material by providing electrical signals to a set of electrodes provided thereto. The volume of electromechanically active material has a general rectangular cuboid shape with a first, main, axis that is longer than a second and third axis, mutually perpendicular and both perpendicular to the first axis. A single drive pad is provided, protruding from the volume of electromechanically active material in a direction parallel to the third axis. The exciting of the volume of electromechanically active material comprises exciting of a first, a second, a third and a fourth part volume of the volume of electromechanically active material independently of each other. The first and second part volumes are situated at a first longitudinal side, along the first axis, with respect to the single drive pad. The third and fourth part volume are situated at a second longitudinal side, opposite to the first longitudinal side, along the first axis, with respect to the single drive pad. The first and third part volumes are situated at a first transverse side, along the second axis, with respect to the single drive pad. The second and fourth part volumes are situated at a second transverse side, opposite to the first transverse side, along the second axis, with respect to the single drive pad.

In a fourth aspect, a method for driving an electromechanical motor comprises arranging of a first electromechanical actuator against a drive surface of a body to be moved. A normal force is provided between a single drive pad of the first electromechanical actuator and the body to be moved. The first electromechanical actuator is driven according to the third aspect.

One advantage with the proposed technology is that a plural-direction motion can be provided by a single actuator, enabling a more compact design for multi-directional actuator or motor arrangements. Other advantages will be appreciated when reading the detailed description.

### BRIEF DESCRIPTION OF THE DRAWINGS

The invention, together with further objects and advantages thereof, may best be understood by making reference to the following description taken together with the accompanying drawings, in which:

FIG. 1 is a schematic elevational illustration of an embodiment of an electromechanical actuator;

FIGS. 2A-D are schematical drawings of different actuator shapes of an embodiment of a first vibrational mode;

FIG. 2E illustrates a path of a drive pad enabled by the first vibrational mode;

FIGS. 3A-E are schematical drawings of different actuator shapes of an embodiment of a second vibrational mode;

FIG. 3F illustrates a path of a drive pad enabled by the second vibrational mode;

FIG. 4 illustrates schematically an embodiment of an electromechanical actuator having a bimorph structure;

FIGS. 5A-B illustrate schematically other embodiments of an electromechanical actuator having a bimorph structure;

FIG. 6A illustrates schematically an embodiment of an 6A electromechanical actuator having a unimorph structure;

FIGS. 6B-D illustrates different embodiments of actuator bendings enabled by a unimorph structure;

FIG. 7 is a flow diagram of steps of an embodiment of a method for driving an electromechanical actuator;

FIG. 8A is a schematic drawing of an embodiment of an electromechanical motor with one electromechanical actuator;

FIGS. 8B-C are illustrations of possible paths enabled by the electromechanical motor of FIG. 8A;

FIG. 9A is a schematic drawing of an embodiment of an electromechanical motor with two electromechanical actuators;

FIGS. 9B-D are illustrations of possible motions enabled by the electromechanical motor of FIG. 9A;

FIG. 10A is a schematic drawing of another embodiment of an electromechanical motor with two electromechanical actuators;

FIGS. 10B-D are illustrations of possible motions enabled by the electromechanical motor of FIG. 10A;

FIG. 11A is a schematic drawing of an embodiment of an electromechanical motor with two electromechanical actuators and a spherically shaped drive surface;

FIGS. 11B-D are illustrations of possible motions enabled by the electromechanical motor of FIG. 11A;

FIG. 12 is a schematic drawing of an embodiment of a twin-design electromechanical motor with four electromechanical; and

FIG. 13 is a flow diagram of steps of an embodiment of a method for driving an electromechanical motor.

### DETAILED DESCRIPTION

Throughout the drawings, the same reference numbers are used for similar or corresponding elements.

In the description below, electromechanically active materials are mentioned. Non-exclusive examples of such electromechanically active materials are piezoelectric materials and electrostrictive materials.

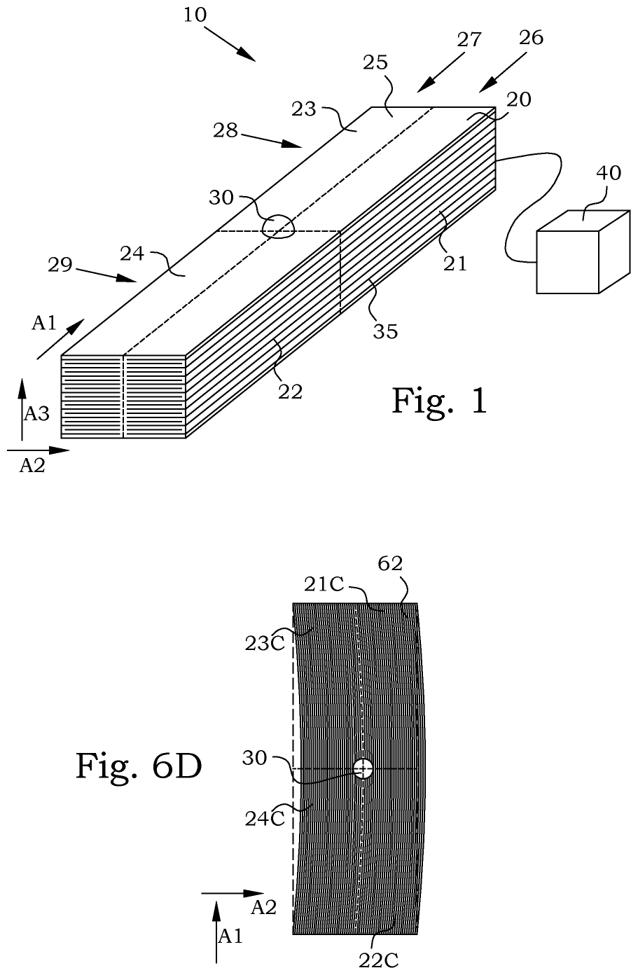

FIG. 1 illustrates an embodiment of an electromechanical actuator 10 in a perspective view. The electromechanical actuator 10 comprises a volume comprising electromechanically active material 20. The volume comprising electromechanically active material 20 has a general rectangular cuboid shape. A first, main, axis A1 is longer than a second axis A2 and a third axis A3. The second axis A2 and the third axis A3 are mutually perpendicular and both are perpendicular to the first axis A1. A single drive pad 30 protrudes from the volume of electromechanically active material 20 in a direction parallel to the third axis A3. In other words, any intended contact between the electromechanical actuator 10 and a surface with which it is supposed to interact is provided by this single drive pad 30. In the present embodiment, the drive pad 30 is situated in the middle of a surface 25 of the volume comprising electromechanically active material. This surface 25 of the volume comprising electromechanically active material has a normal in the direction of the third axis A3, i.e. the surface 25 is parallel to the axis A1 and the axis A2.

The volume of electromechanically active material 20 has a first part volume 21 and a second part volume 22 situated at a first longitudinal side 26, along the first axis A1, with respect to the single drive pad 30. The volume of electromechanically active material 20 has further a third part volume 23 and a fourth part volume 24 situated at a second longitudinal side 27 along the first axis A1, with respect to the single drive pad 30. The second longitudinal side 27 is located opposite to the first longitudinal side 26, with respect to the single drive pad 30.

The first and third part volumes 21, 23 are situated at a first transverse side 28, along the second axis A2, with respect to the single drive pad 30. Analogously, the second and fourth part volumes 22, 24 are situated at a second transverse side 29, along the second axis A2, with respect to the single drive pad 30. The second transverse side 29 is located opposite to the first transverse side 28, with respect to the single drive pad 30.

A set of electrodes 35 are arranged for exciting the volume of electromechanically active material 20 by means of electrical signals. The set of electrodes 35 is provided for allowing excitation of the first, second, third and fourth part volumes 21, 22, 23, 24 independently of each other. In this embodiment, the set of electrodes 35 is configured for applying electrical fields in the direction of the third axis A3 for exciting the part volumes.

The provision of four part volumes that are possible to excite independently of each other, different shape changes of the volume of electromechanically active material 20 can be achieved. These shape changes are together capable of moving the single drive pad in paths having components in directions of all three axes A1, A2, A3. The thus enables interaction with a surface of a body to be moved that is capable of creating motions in more than one direction. In this embodiment, a control unit 40 is provided and arranged for providing electrical signals to the set of electrodes 35.

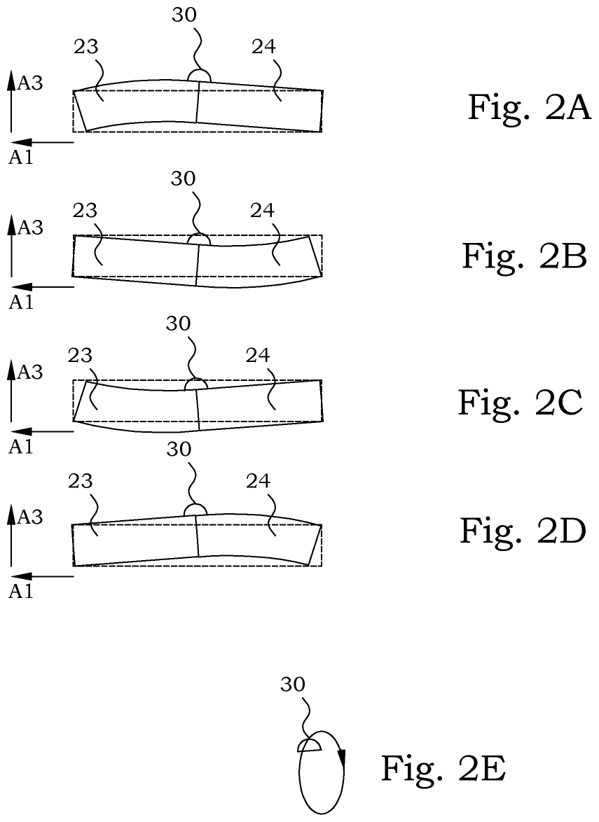

One vibration mode that is useful in this context is illustrated schematically in FIGS. 2A-D. The volume of electromechanically active material 20 is here shown in the direction of the A2 axis and the third and fourth part volumes 23, 24 are therefore seen. In FIG. 2A, the third part volume 23 is excited in such a way that the third part volume 23 bends upwards. The fourth part volume 24 is simultaneously basically unexcited and remains therefore in a plane configuration. The tip of the drive pad 30 is thereby moved upwards in the direction of the axis A3 as well as somewhat to the right, in a direction opposite to axis A1, compared to a completely unexcited volume of electromechanically active material 20. In FIG. 2B, the third part volume 23 is instead basically unexcited and remains therefore in a plane configuration. Instead, the fourth part volume 24 is excited in such a way that the fourth part volume 24 bends downwards. The tip of the drive pad 30 is thereby moved downwards in a direction opposite to the axis A3 as well as somewhat to the right, in a direction opposite to axis A1, compared to a completely unexcited volume of electromechanically active material 20. In FIG. 2C, the third part volume 23 is excited in such a way that the third part volume 23 bends downwards. The fourth part volume 24 is simultaneously basically unexcited and remains therefore in a plane configuration. The tip of the drive pad 30 is thereby moved downwards in the direction of the axis A3 as well as somewhat to the left, in a direction of axis A1, compared to a completely unexcited volume of electromechanically active material 20. In FIG. 2D, the third part volume 23 is instead basically unexcited and remains therefore in a plane configuration. Instead, the fourth part volume 24 is excited in such a way that the fourth part volume 24 bends upwards. The tip of the drive pad 30 is thereby moved upwards in a direction opposite to the axis A3 as well as somewhat to the left, in a direction of axis A1, compared to a completely unexcited volume of electromechanically active material 20. The first and second part volumes, not shown, are excited in an analogue manner to the third and fourth part volumes 23, 24, respectively.

In this way, the tip of the drive pad 30 can be moved in a two-dimensional plane, spanned by the axes A1 and A3. A repetitive such movement of the tip of the drive pad 30 typically provides a driving action on a surface held in contact with the drive pad directed in the direction of the first axis (or opposite thereto), i.e. parallel to the first axis.

In other words, in this embodiment, the control unit 40 is configured to provide electrical signals to the set of electrodes 35 causing a first vibration mode of bending vibrations having strokes in a direction parallel to the third axis. Thereby, the single drive pad becomes capable of providing an actuating action in the direction parallel to the first axis.

The above illustrated bending strokes, and strokes between them can be achieved by supplying repetitive voltage signals to the part volumes. In this embodiment, the control unit 40 is configured for achieving the first vibration mode by exciting the first, second, third and fourth part volumes 21-24 with signals having the same frequency. The first and third part volumes 21, 23 are excited in-phase with each other. The second and fourth part volumes 22, 24 are excited in-phase with each other. The first and second part volumes 21, 22 are, however, excited out-of-phase relative each other, which implies that also the third and fourth part volumes 23, 24 are excited out of phase.

The phase difference can be used to select an appropriate path of the tip of the drive pad 30. This path has typically an elliptical shape, as indicated in FIG. 2E. If a small phase difference is used, the tip of the drive pad 30 will move mainly in the A3 direction, and only with a minor component in the A1 direction. If a phase difference close to 180 degrees is used, the tip of the drive pad 30 will move mainly in the A1 direction and with a minor component in the A3 direction. In such a way, the relation between the movements in the different directions can be adapted by selecting an appropriate phase difference. The direction of the created movement is also controlled by the phase difference. The interaction force against any driving surface will be higher when the drive pad is displaced upwards (in the figure), i.e. in the A3 direction. Any motion in the A1 direction will thereby be transferred to the contacted surface. When the drive pad in stead is retracted, i.e. moved in a direction opposite to A3, the driving action is less and there may even be a release from the driven surface, during which the drive pad tip can be moved in the opposite A1 direction. By changing the polarity of the phase difference, the driving direction can thus be changed. Such driving principles are, as such, well known in the art of piezoelectric motors.

Note that the bending strokes that are illustrated in the figures are tremendously exaggerated for illustrational purposes. In typical practice, the shape changes are much smaller.

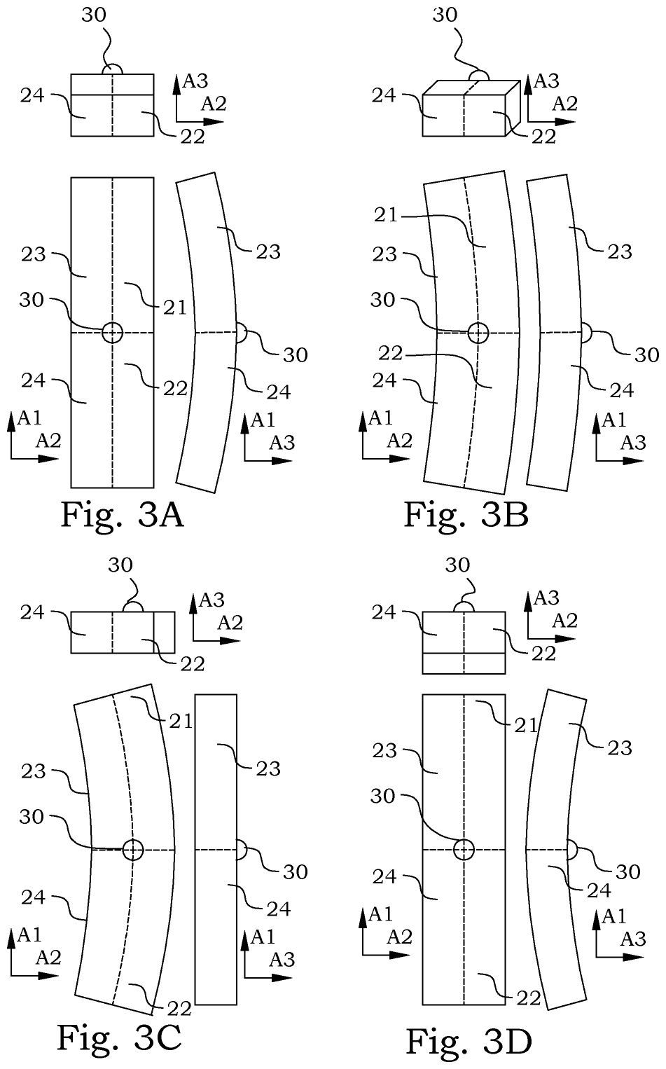

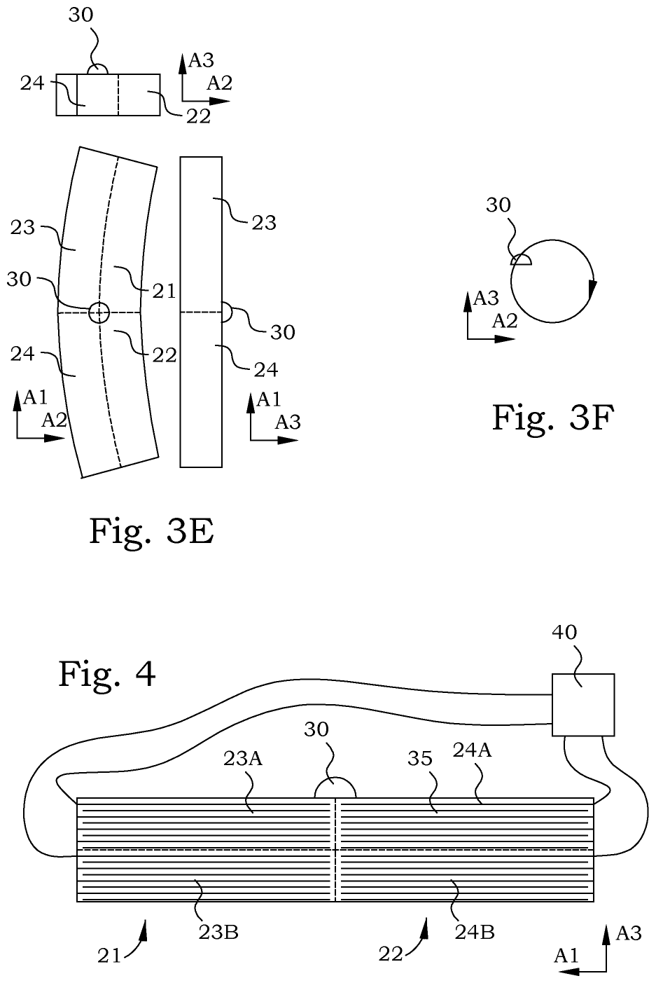

The allowance of exciting the first, second, third and fourth part volumes 21, 22, 23, 24 independently of each other also gives possibilities to further vibration modes. One such further vibration mode that is useful in this context is illustrated schematically in FIGS. 3A-F. The FIGS. 3A-E each illustrates three views of the volume of electromechanically active material 20 under certain excitation conditions. The arrows indicate the different views. In this embodiment, the control unit is thus also configured to provide electrical signals to the set of electrodes causing a second vibration mode. This second vibration mode has vibration strokes with second mode components in a direction of the second axis A2 and other second mode components in a direction of the third axis A3. Thereby, the single drive pad 30 becomes capable of providing an actuating action in a direction of the second axis A2.

In FIG. 3A, all part volumes 21-24 are excited to give a bending in the direction of axis A3. The drive pad 30 is thereby displaced in the direction of axis A3 compared to an unexcited condition. In FIG. 3B, all part volumes 21-24 are also excited to give a bending in the direction of axis A3, however of a slightly less magnitude. Moreover, superimposed on this excitation, an excitation of the entire first part volume 21 and the entire second part volume 22 is provided causing an expansion of the part volume dimension in the direction of axis A1. The third and fourth part volumes 23, 24 are analogously provided with excitations causing a smaller expansion in the direction of axis A1 or a compression in the direction of axis A1. This causes the entire volume to bend with a stroke in the direction of the axis A2. In FIG. 3B, the volume of electromechanically active material is bent in the direction of the axis A2 as well as in the direction of the axis A3.

In FIG. 3C, the bending of the part volumes in the direction of axis A3 is removed. However, the excitation of the part volumes that causes the bending in the direction of axis A2 is maintained. The same principles are of course available for bendings in the opposite directions. In FIG. 3D, all part volumes 21-24 are excited to perform a bending in a direction opposite to axis A3. In FIG. 3E, the part volumes 23 and 24 are excited to give a larger expansion or smaller compression parallel to axis A1 than the part volumes 21 and 22. This results in that the volume of electromechanically active material is bent in the direction opposite to the axis A2.

By combining the different excitation signals in a proper way, a movement path of the drive pad 30 as illustrated in FIG. 3F can be achieved. A circular, or in a more general case, an elliptical path can be obtained in the plane of axis A2 and A3, which can be used to obtain a driving action of a surface in contact with the drive pad in a direction parallel to axis A2.

By reversing the time dependencies of the applied excitation signals, the drive pad path can be reversed. This is made in analogy with the vibration mode of FIGS. 2A-2E. In such a way, the relation between the movements in the different directions can be adapted by selecting an appropriate phase difference. The direction of the created movement is also controlled by the phase difference.

In other words, in one embodiment, the control unit is configured for achieving the second vibration mode by exciting the first, second, third and fourth part volumes with signals having the same frequency. The first and second part volumes are excited in-phase with each other. The third and fourth part volumes are excited in-phase with each other. The first and third part volumes are excited out-of-phase relative each other.

Note that the bending strokes that are illustrated in the figures are tremendously exaggerated for illustrational purposes. In typical practice, the shape changes are much smaller.

Returning to FIG. 1, it is now understood that the configuration of the volume of electromechanically active material 20 with four independently excitable part volumes opens up for driving mechanisms in a direction parallel to axis A1 as well as in a direction parallel to axis A2 with a single actuator body. By alternating between these two driving directions in different relations, a motion according to any path in a two-dimensional space can be achieved.

In order to facilitate such a motion in two perpendicular directions, the drive pad 30 is preferably designed without any sharp edges close to the contact tip. This is to avoid any unintentional gripping into a surface to be driven if the drive pad is slightly tilted. In other words, the single drive pad 30 has preferably a contact tip presenting a curvature in directions parallel to both the first axis A1 and the second axis A2. In the present illustration, the drive pad 30 has the shape of a part of a sphere. However, many other geometries are also possible.

In one embodiment of an electromechanical actuator according to the above mentioned principles, each of the first, second, third and fourth part volumes are capable of providing a bending of the respective part volume as a reply to certain excitation signals. Such a bending can be provided in different ways. FIG. 4 illustrates one embodiment, where the first, second, third and fourth part volumes 21-24 are provided as bimorph structures. Part volumes 21 and 22 are in this view hidden behind the part volumes 23 and 24. Each of these bimorph structures comprises a first respective section 23A, 24A and a second respective section 23B, 24B of active electromechanically active material. These first and second sections 23A-B, 24A-B are excitable independently of each other. The first sections 23A, 24A are firmly attached to the respective second sections 23B, 24B in the direction of the third axis A3. When the first section 23A, 24A is excited in a different manner, causing different shape or dimension changes, than the respective second section 23B, 24B, this attachment causes the composed part volume 23, 24, respectively, to bend.

In the embodiment of FIG. 4, the set of electrodes 35 is configured for applying electrical fields in the direction of said third axis A3 for exciting the part volumes 21-24. However, alternative excitation principles can be used, depending on and in combination with e.g. the polarization of the piezoelectric material.

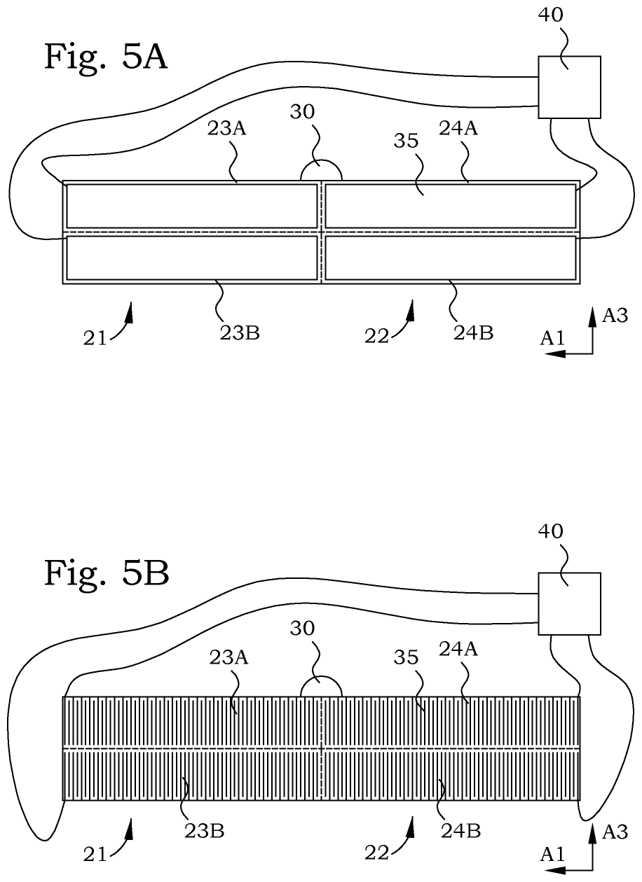

FIG. 5A illustrates schematically another embodiment, where the set of electrodes 35 are provided perpendicular to the axis A2. Thus, in this embodiment, the set of electrodes 35 is configured for applying electrical fields in the direction of the second axis A2 for exciting the part volumes 21-24.

FIG. 5B illustrates schematically yet another embodiment, where the set of electrodes 35 are provided perpendicular to the axis A1. Thus, in this embodiment, the set of electrodes 35 is configured for applying electrical fields in the direction of the first axis A1 for exciting the part volumes 21-24.

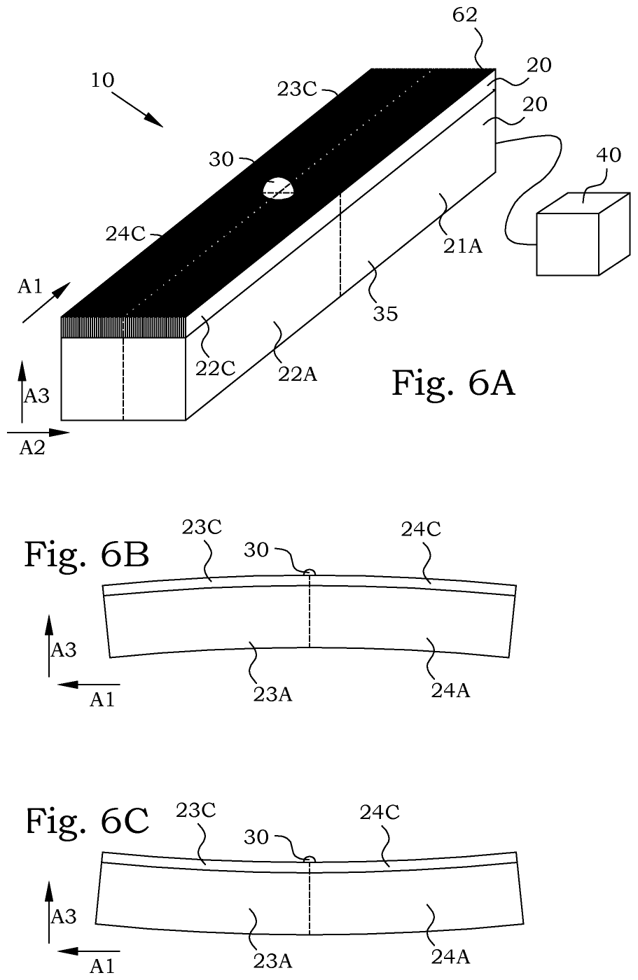

The bending action of the part volumes may be achieved also without using bimorph structures. FIG. 6A illustrates schematically one embodiment of an electromechanical actuator operating with unimorph structures instead.

In this embodiment, the first, second, third and fourth part volumes 21-24 are parts of unimorph structures. The unimorph structures comprises a first respective section 21A-24A of active electromechanically active material and a third respective section 21C-24C being electromechanically non-excitable. The respective third sections 21C-24C are firmly attached to a respective one of the first sections 21A-24A in the direction of the third axis. If the flexural stiffness in the different directions is uniform, the movement in the direction of the axis A2 might be somewhat damped but is in typical cases large enough to provide the necessary movement.

In a preferred embodiment, the respective third section 21C-24C presents a low flexural stiffness in the direction of the second axis A2 compared to the other directions. Preferably, this flexural stiffness is less than 10% of a flexural stiffness in the direction of the second axis A2 of the first respective section 21A-24A.

In this particular embodiment, the third sections 21C-24C comprises a set of ribs 62, with a height in the direction of axis A3 that is considerably larger than a width in the direction of axis A2. These ribs 62 are thus relatively easily bended with strokes in the direction parallel to axis A2, while at least partly prohibiting bending actions in the direction parallel to axis A3. Other types of geometries giving the same type of bending restrictions are also possible.

When the part volumes 21-24 are excited to achieve a compression in the direction parallel to axis A1, the respective third sections 21C-24C cannot adapt to this compression and a bending of the unimorph structure will be the result, as schematically illustrated in FIG. 6B. The bending is directed upwards, in the figure, i.e. in the direction of axis A3. Analogously, when the part volumes 21-24 are excited to achieve an expansion in the direction parallel to axis A1, the respective third sections 21C-24C cannot adapt to this compression and a bending of the unimorph structure will be the result, as schematically illustrated in FIG. 6CB. The bending is directed downwards, in the figure, i.e. in the direction opposite of axis A3.

In the present embodiment, the drive pad is attached to the side of the actuator of the third sections 21C-24C. However, the drive pad may in alternative embodiments be attached to the first sections 21A-24A, resulting in an opposite movement of the drive pad in the direction of the third axis.

FIG. 6D illustrates an electromechanical actuator in a state where the part volumes 21 and 22 are excited differently compared to the part volumes 23 and 24. This causes a bending of the actuator, due to the fact that the pair of part volume 21 and part volume 23 forms a bimorph structure and the pair of part volume 22 and part volume 24 forms another bimorph structure. In this case, the respective third sections 21C-24C will follow the bending of these bimorph structures, due to the low flexural stiffness in the direction of the second axis A2.

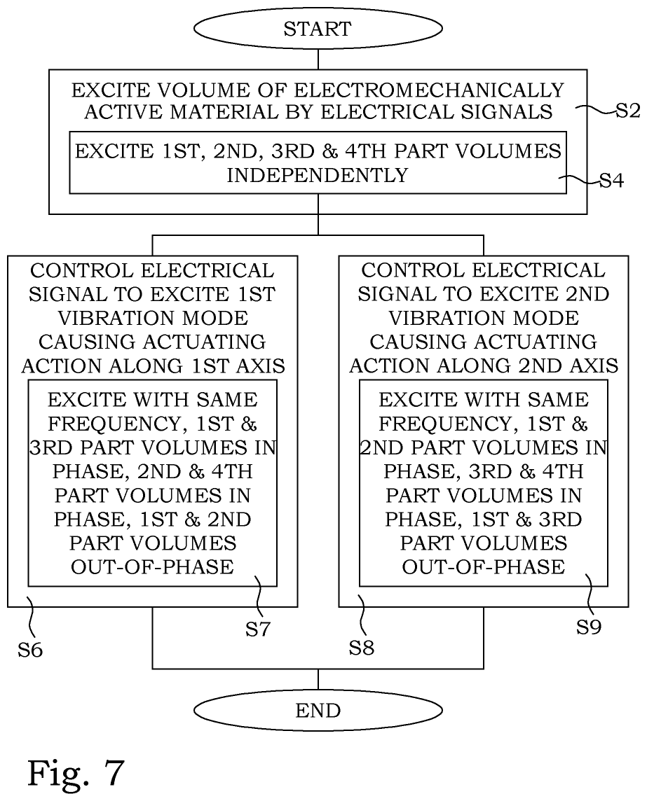

FIG. 7 is a flow diagram of steps of an embodiment of a method for driving an electromechanical actuator. In step S2, a volume of electromechanically active material is excited by providing electrical signals to a set of electrodes provided thereto. The volume of electromechanically active material has a general rectangular cuboid shape with a first, main, axis that is longer than a second and third axis, mutually perpendicular and both perpendicular to the first axis. A single drive pad is provided, protruding from the volume of electromechanically active material in a direction parallel to the third axis. The step S2 of exciting a volume of electromechanically active material comprises the step S4, in which a first, a second, a third and a fourth part volume of the volume of electromechanically active material are excited of independently of each other.

The first and second part volumes are situated at a first longitudinal side, along the first axis, with respect to the single drive pad and the third and fourth part volume are situated at a second longitudinal side, opposite to the first longitudinal side, along the first axis, with respect to the single drive pad. The first and third part volumes are situated at a first transverse side, along the second axis, with respect to the single drive pad and the second and fourth part volumes are situated at a second transverse side, opposite to the first transverse side, along the second axis, with respect to the single drive pad.

As mentioned above, in a preferred embodiment, the exciting S2 of a volume of electromechanically active material is performed by applying electrical fields in the direction of the third axis in the part volumes.

In another embodiment, the exciting S2 of a volume of electromechanically active material is performed by applying electrical fields in the direction of the second axis in the part volumes.

In yet another embodiment, the exciting S2 of a volume of electromechanically active material is performed by applying electrical fields in the direction of the first axis in the part volumes.

In one preferred embodiment, the electrical signals to the set of electrodes are in step S6 controlled to excite the volume of electromechanically active material in a first vibration mode of bending vibrations. The first vibration mode of bending vibrations has strokes in a direction of the third axis. The first vibration mode causes the single drive pad to provide an actuating action in the direction of the first axis.

Preferably, as illustrated by step S7, the first vibration mode is achieved by exciting the first, second, third and fourth part volumes with signals having the same frequency. The first and third part volumes are furthermore excited in-phase with each other. The second and fourth part volumes are excited in-phase with each other. However, the first and second part volumes are excited out-of-phase relative each other. Thereby, the third and fourth part volumes are also excited out-of-phase relative each other.

In one preferred embodiment, the electrical signals to the set of electrodes are in step S8 controlled to excite the volume of electromechanically active material in a second vibration mode of vibrations. This second vibration mode of vibrations has strokes with second mode components in a direction parallel to the second axis and other second mode components in a direction parallel to the third axis. The second vibration mode causes the single drive pad to provide an actuating action in the direction of the second axis.

Preferably, as illustrated in step S9, the second vibration mode is achieved by exciting the first, second, third and fourth part volumes with signals having the same frequency. The first and second part volumes are excited in-phase with each other. The third and fourth part volumes are excited in-phase with each other. However, the first and third part volumes are excited out-of-phase relative each other. Thereby, the second and fourth part volumes are also excited out-of-phase relative each other.

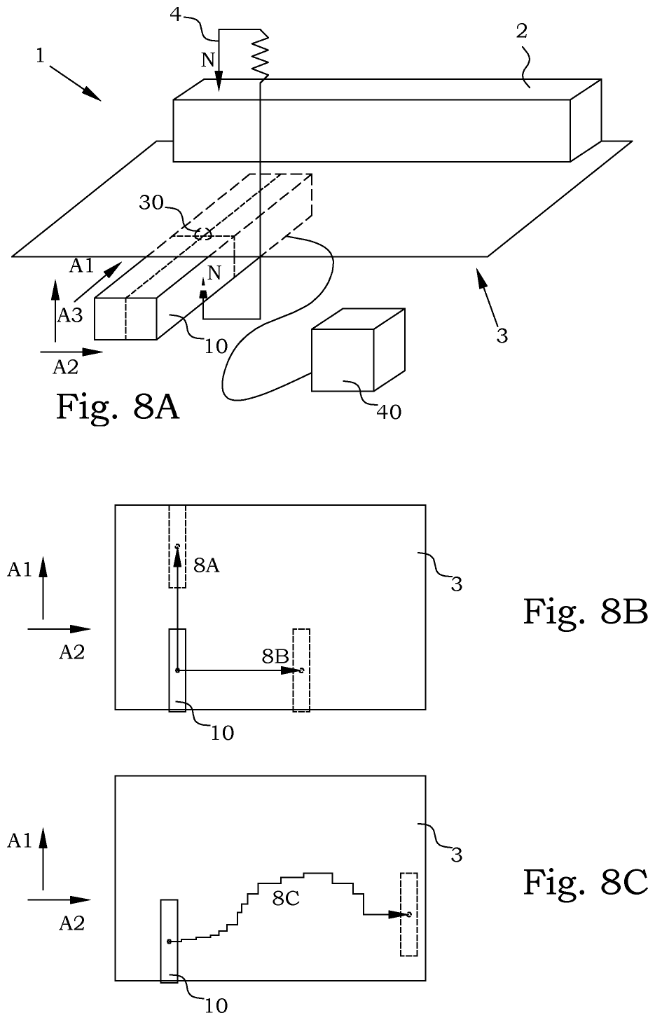

The dual-directional actuators described above can be utilized in different motor configurations, enabling multi-axis translations as well as rotations. FIG. 8A illustrates schematically one embodiment of an electromechanical motor 1. The electromechanical motor 1 comprises an electromechanical actuator 10 according to the ideas presented above. The electromechanical motor 1 further comprises a body to be moved 2. The body to be moved 2 has a drive surface 3, arranged against the single drive pad 30 of the electromechanical actuator 10. A normal-force providing means 4 is configured for applying a normal force N between the single drive pad 30 and the body to be moved 2 in a direction parallel to the third axis A3.

The movements of the tip of the drive pad 30 are transferred into a movement of the drive surface 3. When the movements of the drive pad 30 are made fast enough, the mass inertia of the body to be moved 2 and the electromechanical actuator 10 allows the drive pad 30 to be released from the drive surface 3, when it is moved in the direction opposite to axis A3. In such a way, the movements in the directions parallel to the axis A1 and A2 during these phases are not transferred to the drive surface 3. At the contrary, when the drive pad 30 moves in the direction of axis A3, there will be a contact between the drive pad 30 and the drive surface 3, which means that the movements in the directions parallel to the axis A1 and A2 during these phases are transferred to the drive surface 3. In such a way, a relative movement of the drive surface 3 and the electromechanical actuator 10 can be obtained.

Since the electromechanical actuator 10 of FIG. 8A is configured for moving the drive pad in two perpendicular directions, relative movements 8A, 8B of the drive pad 30 and the drive surface 3 can also be provided in these directions, as illustrated in FIG. 8B. By combining small periods of these two different drive directions, relative movements of the drive pad 30 and the drives surface 3 in any selected direction and in any path in the plane of axis A1 and A2 can be achieved, as illustrated in FIG. 8C.

In FIG. 8A, the drive surface 3 is a planar surface. However, also different kinds of curved surfaces can be utilized as drive surfaces. As long as the curvature of the drive surfaces allows for the drive pad to be the only contact point therebetween, a two-dimensional relative translational motion along the drive surfaces can be achieved, defined by the shape of the drive surface.

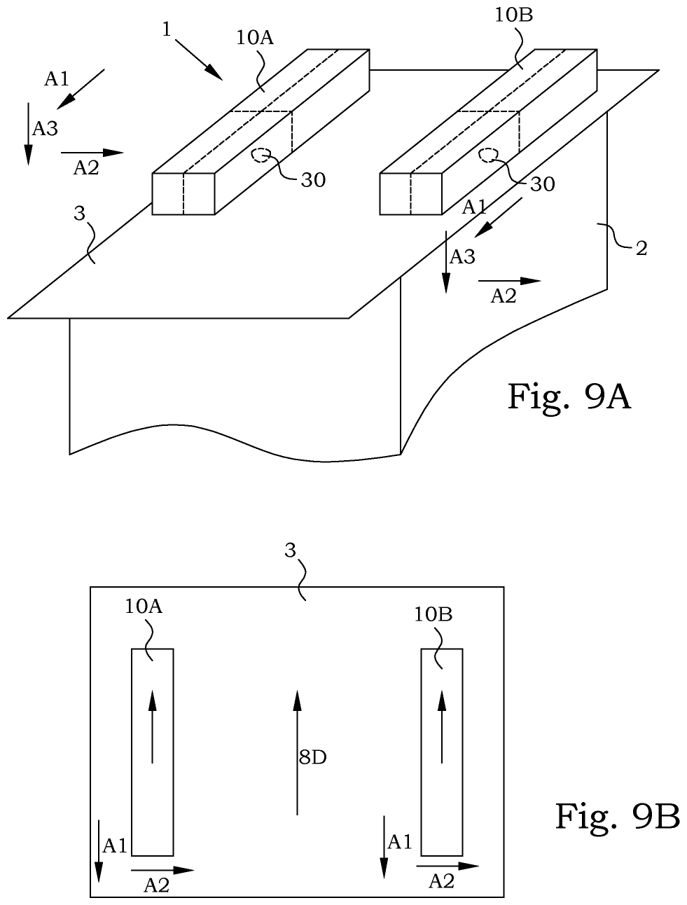

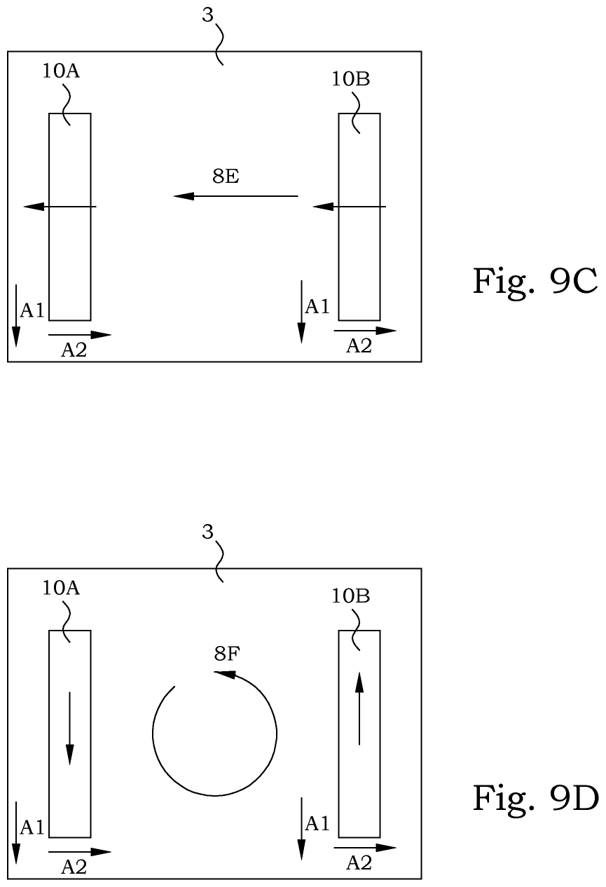

Even more degrees of movement freedom can be achieved if more than one electromechanical actuator is arranged to act on the same body to be moved. In FIG. 9A a schematic illustration of an electromechanical motor 1 with two electromechanical actuators 10A, 10B is shown. Note that the axis A3 is turned upside down compared to the previous figures. The normal force applying means is also omitted. A second electromechanical actuator 10B according to the principles described above is arranged with the (hidden) single drive pad 30 of the second electromechanical actuator 10B against the drive surface 3 of the body to be moved. Alternatively, the second electromechanical actuator 10B can be arranged against a second drive surface rigidly attached to the body to be moved 2. In other words, the drive surfaces on which the two electromechanical actuators 10A, 10B are acting do not need to be a continuous surface used by both electromechanical actuators 10A, 10B, but can be two separate surfaces rigidly attached to each other.

In the embodiment of FIG. 9A, the drive surface(s) 3 is a planar surface.

In the embodiment of FIG. 9A, the electromechanical actuators are positioned such that the first axis of the first electromechanical actuator 10A is arranged parallel to the first axis of the second electromechanical actuator 10B. This setup allows the body to be moved to be moved in two translational directions as well as being rotated. If both the electromechanical actuators 10A, 10B are driven in a same direction, e.g. the direction of the respective first axes, as illustrated in FIG. 9B, the drive surface 3 will also be driven in this direction in a translational movement, illustrated by arrow 8D. If both the electromechanical actuators 10A, 10B are driven in a same direction, but now in the direction of the respective second axes, as illustrated in FIG. 9C, the drive surface 3 will also be driven in this direction in a translational movement illustrated by the arrow 8E. By combining small steps of such translational movements, any two-dimensional movement pattern along the drive surface 3 can be achieved.

In addition, if both electromechanical actuators 10A, 10B are driven parallel to the respective first axes, but in opposite direction, as illustrated in FIG. 9D, a rotation of the drive surfaces 3 relative to the electromechanical actuators 10A, 10B will be obtained, as illustrated by the arrow 8F. So, by use of two electromechanical actuators 10A, 10B, any movement along the drive surface, including rotational movements, can be performed.

The relative placement between the electromechanical actuators can also be varied in many ways. In one embodiment, the first axis of the first electromechanical actuator is arranged transverse to the first axis of the second electromechanical actuator.

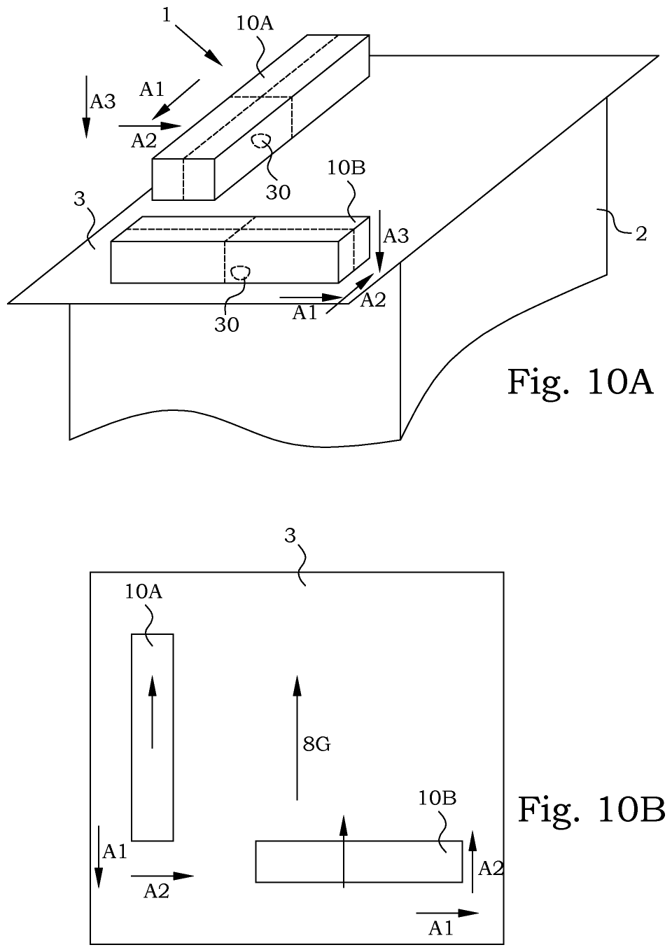

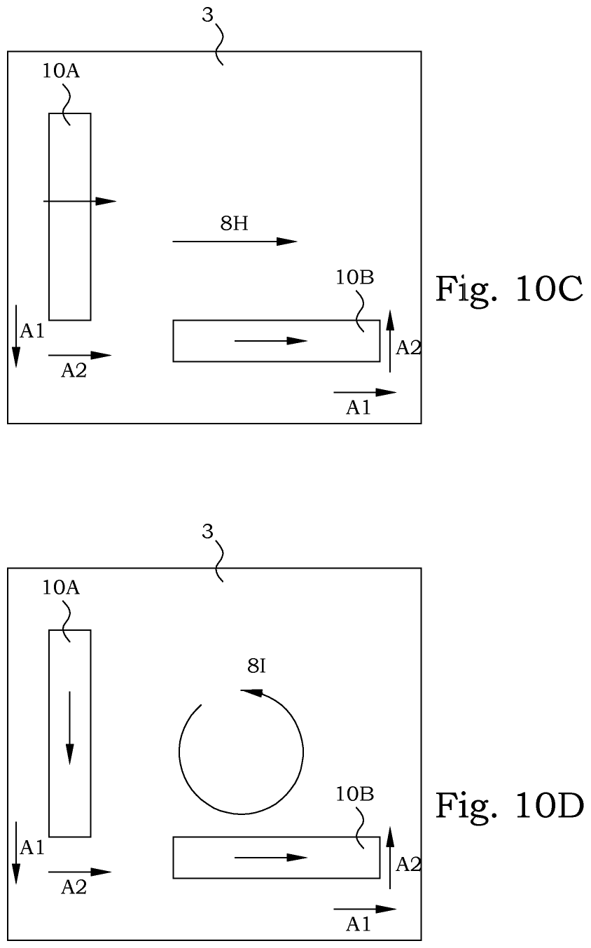

In FIG. 10A, an electromechanical motor 1 is illustrated, where the first axis A1 of the first electromechanical actuator 10A is arranged perpendicular to the first axis A1 of the second electromechanical actuator 10B. This setup also allows the body to be moved to be moved in two translational directions as well as being rotated. If both the electromechanical actuators 10A, 10B are driven in a same direction, e.g. the direction of the first axis of the first electromechanical actuator 10A and the direction of the second axis A2 of the second electromechanical actuators 10B, as illustrated in FIG. 10B, the drive surface 3 will also be driven in this direction in a translational movement, illustrated by arrow 8G. If both the electromechanical actuators 10A, 10B are driven in a same direction, but now in the direction of the first axis of the second electromechanical actuator 10B and the direction of the second axis A2 of the first electromechanical actuators 10A, as illustrated in FIG. 10C, the drive surface 3 will also be driven in this direction in a translational movement illustrated by the arrow 8H. By combining small steps of such translational movements, any two-dimensional movement pattern along the drive surface 3 can be achieved.

In addition, if both electromechanical actuators 10A, 10B are driven parallel to the respective first axes, as illustrated in FIG. 10D, a rotation of the drive surfaces 3 relative to the electromechanical actuators 10A, 10B will be obtained, as illustrated by the arrow 8I. So, by use of two electromechanical actuators 10A, 10B, any movement along the drive surface, including rotational movements, can be performed.

The drive surfaces may also have other shapes. In one embodiment the drive surface is a part of a spherical surface. A first tangent plane of the drive surface at a first contact point with the single drive pad of the first electromechanical actuator is parallel to the first axis and the second axis of the first electromechanical actuator, and a second tangent plane of the drive surface at a second contact point with the single drive pad of the second electromechanical actuator is parallel to the first axis and the second axis of the second electromechanical actuator.

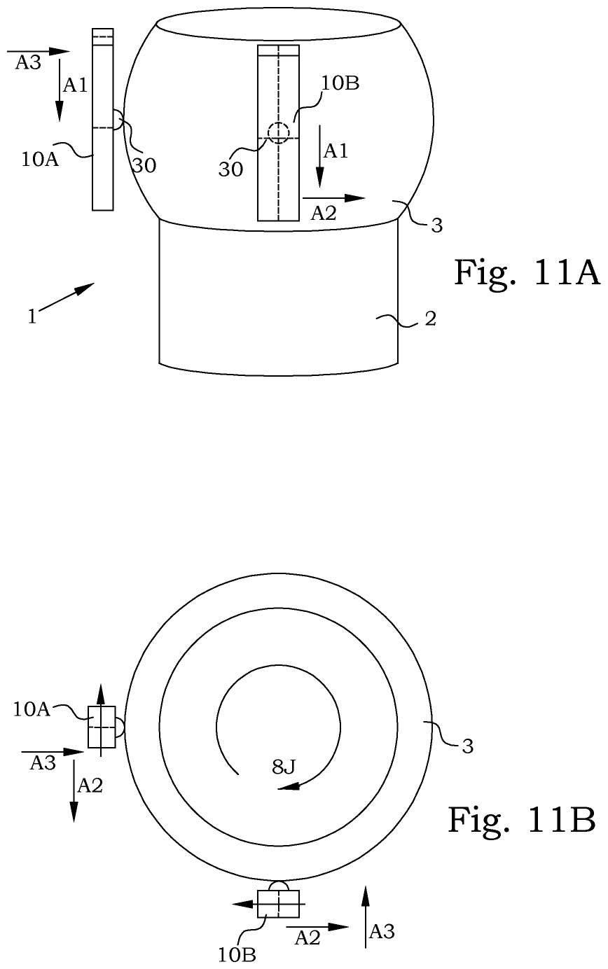

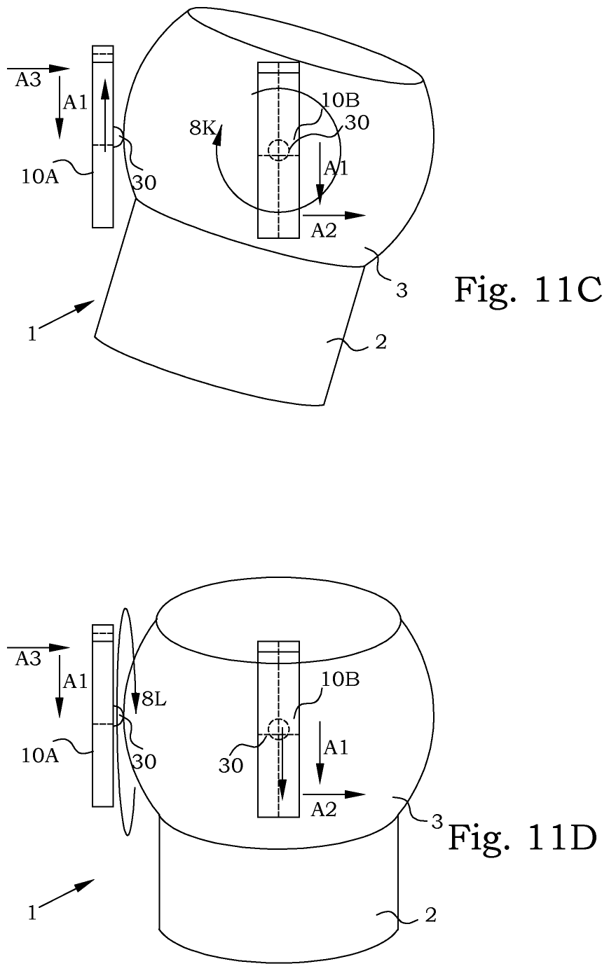

FIG. 11A illustrates an embodiment of an electromechanical motor 1, where the drive surface 3 is a part of a spherical surface. In this embodiment the first axis A1 of the first electromechanical actuator 10A is arranged parallel to the first axis A1 of the second electromechanical actuator 10B. in a particular embodiment, the third axis A3 of the first electromechanical actuator 10A is arranged perpendicular to the third axis, pointing into the paper plane in the figure, of the second electromechanical actuator 10B.

This setup also allows the body to be moved to be rotated around three different rotational axes. If both the electromechanical actuators 10A, 10B are driven in a same direction, in a direction parallel to the respective second axis A2 of the electromechanical actuators 10A, 10B, as illustrated from above in FIG. 11B, the drive surface 3 will be rotated around an axis parallel to the first axis A1 of the electromechanical actuators 10A, 10B, illustrated by arrow 8J. If only the electromechanical actuator 10A is driven, in a direction parallel to the axis A1, as illustrated in FIG. 11C, the drive surface 3 will rotate around an axis through the drive pad 30 of the second electromechanical actuator 10B and directed in to the paper of the drawing, as illustrated by the arrow 8K. If only the electromechanical actuator 10B is driven, in a direction parallel to the axis A1, as illustrated in FIG. 11D, the drive surface 3 will rotate around an axis through the drive pad 30 of the first electromechanical actuator 10B and directed parallel to the axis A3 of the first electromechanical actuator 10A, as illustrated by the arrow 8L.

In an alternative embodiment, the electromechanical actuators 10A, 10B may be provided with the first axes A1 horizontally (with reference to the geometries illustrated in FIG. 11A). In such an embodiment, the first axis of the first electromechanical actuator is arranged transverse to the first axis of the second electromechanical actuator. In a particular embodiment, the first axis of the first electromechanical actuator is arranged perpendicular to the first axis of the second electromechanical actuator. Also, the third axis of the first electromechanical actuator is arranged perpendicular to the third axis of the second electromechanical actuator.

Further similar embodiment may have one of the electromechanical actuators 10A, 10B provided with the respective first axis in a horizontal direction, with reference to FIG. 11A, while the other electromechanical actuator 10A, 10B is provided with the respective first axis in a vertical direction, with reference to FIG. 11A.

Other embodiments are also possible, where the third axes of the different electromechanical actuators are provided in non-perpendicular directions. The possible rotations caused by operation of only one of the electromechanical actuators will then still take place around an axis through the contact point of the drive pad of the inactive electromechanical actuator.

In one embodiment, the drive surface may have an at least partial cylindrical shape.

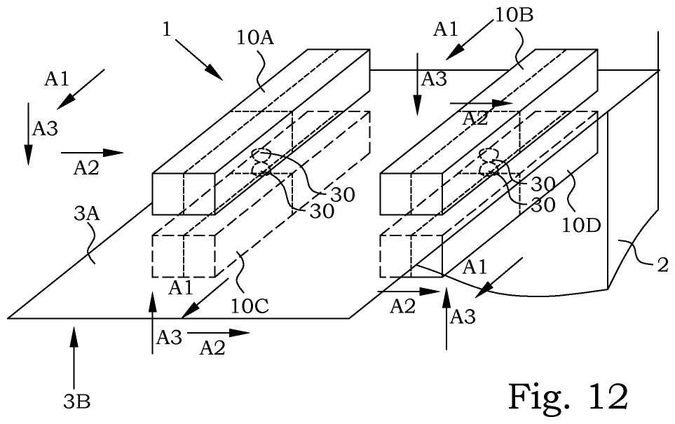

The normal-force providing means 4, as schematically illustrated in FIG. 8A, is, as such, well known in prior art. Typical embodiments of such normal-force providing means 4 are different kinds of spring arrangements. In other commonly used embodiments, a twin-design is used, in which one electromechanical actuator is included as a part of the normal-force providing means of another electromechanical actuator. In FIG. 12, a setup with four electromechanical actuators 10A-10D driving a body to be moved from oppositely positioned parallel drive surfaces 3A, 3B. The electromechanical actuators 10A and 10C are preferably driven with mirrored operations with respect to each other and likewise are electromechanical actuators 10B and 10D.

In other words, in one embodiment, the normal-force providing means comprises at least one additional electromechanical actuator according to the principles described above.

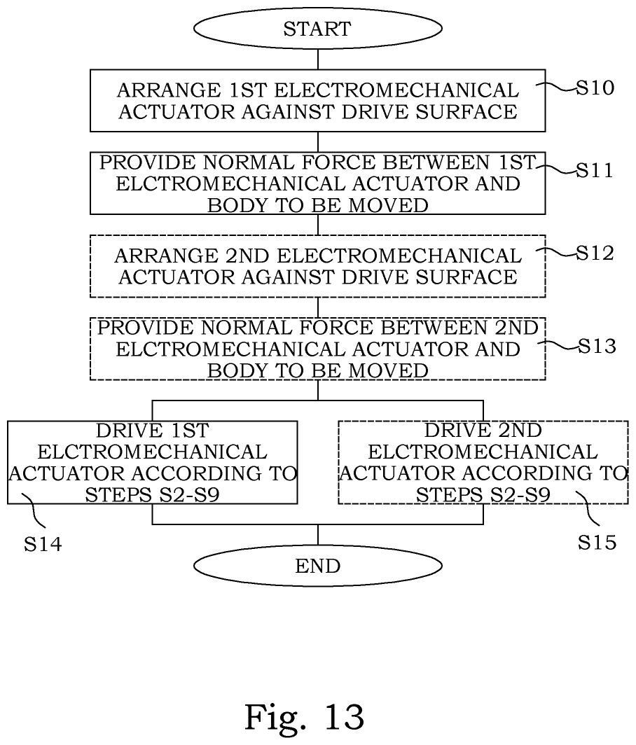

FIG. 13 is a flow diagram of steps of a method for driving an electromechanical motor. In step S10, a first electromechanical actuator is arranging against a drive surface of a body to be moved. In step S11, a normal force is provided between a single drive pad of the first electromechanical actuator and the body to be moved. In step S14, the first electromechanical actuator is driven according to the principles disclosed further above, corresponding to steps S2-S9 of FIG. 7.

In a particular embodiment, in step S12, a second electromechanical actuator is arranged against the drive surface of the body to be moved or against a second drive surface rigidly attached to the body to be moved. In step S13, a normal force is provided between a single drive pad of the second electromechanical actuator and the body to be moved. In step S15, the second electromechanical actuator is driven according to the principles disclosed further above, corresponding to steps S2-S9 of FIG. 7.

In one embodiment, the step of arranging the first electromechanical actuator S10 comprises arranging the first electromechanical actuator against a planar drive surface of the body to be moved. The step of arranging the second electromechanical actuator S12 comprises arranging the second electromechanical actuator against the planar drive surface with the first axis of the first electromechanical actuator parallel to the first axis of the second electromechanical actuator.

In a further embodiment, both the first electromechanical actuator and the second electromechanical actuator are driven in the first vibration mode in the same direction relative the planar surface. This thereby causes a translation of the planar surface relative the first and second electromechanical actuators in the plane of the planar surface along the first axis of the first and second electromechanical actuators.

In a further embodiment, both the first electromechanical actuator and the second electromechanical actuator are driven in the first vibration mode, but in opposite directions relative each other. This thereby causes a rotation of the planar surface relative the first and second electromechanical actuators in the plane of the planar surface.

In a further embodiment, both the first and second electromechanical actuators are driven in the second vibration mode in the same direction relative the planar surface. This thereby causes a translation of the planar surface relative the first and second electromechanical actuators in the second direction of the first and second electrotechnical actuators.

In one embodiment, the step of arranging the first electromechanical actuator S10 comprises arranging the first electromechanical actuator against a planar drive surface of the body to be moved. The step of arranging the second electromechanical actuator comprises S12 arranging the second electromechanical actuator against the planar drive surface with the first axis of the first electromechanical actuator perpendicular to the first axis of the second electromechanical actuator.

In a further embodiment, both the first electromechanical actuator and the second electromechanical actuator are driven in the first vibration mode and/or the second vibration mode. This thereby causes a rotation of the planar surface relative the first and second electromechanical actuators in the plane of the planar surface.

In a further embodiment, the first electromechanical actuator is driven in the first vibration mode. The second electromechanical actuator is driven in the second vibration mode. This thereby causes a translation of the planar surface relative the first and second electromechanical actuators in the first direction of the first electrotechnical actuator.

In one embodiment, the step of arranging the first electromechanical actuator S10 comprises arranging the first electromechanical actuator against a drive surface of the body to be moved being a part of a spherical surface. The step of arranging the second electromechanical actuator S12 comprises arranging the second electromechanical actuator against the drive surface being the part of the spherical surface with the first axis of the first electromechanical actuator perpendicular to the first axis of the second electromechanical actuator and with the third axis of the first electromechanical actuator perpendicular to the third axis of the second electromechanical actuator.

In further embodiments, the first and second electromechanical actuators are arranged with at least one of:
the first axis of the first electromechanical actuator being parallel to the third axis of the second electromechanical actuator and
the first axis of the second electromechanical actuator being parallel to the third axis of the first electromechanical actuator. Preferably both these relations are provided, i.e., arranging the first and second electromechanical actuators with both the first axis of the first electromechanical actuator being parallel to the third axis of the second electromechanical actuator and the first axis of the second electromechanical actuator being parallel to the third axis of the first electromechanical actuator.

In a further embodiment, both the first electromechanical actuator and the second electromechanical actuator are driven in the first vibration mode. This thereby causes a rotation of the surface being a part of a spherical surface relative the first and second electromechanical actuators in a plane of the third axes of the first and second electromechanical actuators.

In a further embodiment, the first electromechanical actuator is driven in the second vibration mode. This thereby causes a rotation of the surface being a part of a spherical surface relative the first and second electromechanical actuators around an axis parallel to the third axes of the second electromechanical actuator.

In one embodiment, the step of arranging the first electromechanical actuator S10 comprises arranging the first electromechanical actuator against a drive surface of the body to be moved being a part of a spherical surface. The step of arranging the second electromechanical actuator S12 comprises arranging the second electromechanical actuator against the drive surface being the part of the spherical surface with the first axis of the first electromechanical actuator parallel to the first axis of the second electromechanical actuator and with the third axis of the first electromechanical actuator perpendicular to the third axis of the second electromechanical actuator.

In a further embodiment, both the first electromechanical actuator and the second electromechanical actuator are driven in the second vibration mode. This thereby causes a rotation of the surface being a part of a spherical surface relative the first and second electromechanical actuators in a plane of the third axes of the first and second electromechanical actuators.

In a further embodiment, the first electromechanical actuator is driven in the first vibration mode. This thereby causes a rotation of the surface being a part of a spherical surface relative the first and second electromechanical actuators around a axis parallel to the third axes of the second electromechanical actuator.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1.-50. (canceled)

51. An electromechanical actuator, comprising:
a volume comprising electromechanically active material;
said volume comprising electromechanically active material having a general rectangular cuboid shape with a first, main, axis that is longer than a second and third axis, mutually perpendicular and both perpendicular to said first axis;
a set of electrodes arranged for exciting said volume of electromechanically active material by means of electrical signals; and
a single drive pad protruding from said volume of electromechanically active material in a direction parallel to said third axis;
wherein said volume of electromechanically active material has a first and second part volume situated at a first longitudinal side, along said first axis, with respect to said single drive pad and a third and fourth part volume situated at a second longitudinal side, opposite to said first longitudinal side, along said first axis, with respect to said single drive pad;
wherein said first and third part volumes being situated at a first transverse side, along said second axis, with respect to said single drive pad and said second and fourth part volumes being situated at a second transverse side, opposite to said first transverse side, along said second axis, with respect to said single drive pad;
said set of electrodes being provided for allowing excitation of said first, second, third and fourth part volumes independently of each other.

52. The electromechanical actuator according to claim 51, further comprising:
a control unit, arranged for providing electrical signals to said set of electrodes;
wherein said control unit is configured to provide electrical signals to said set of electrodes causing a first vibration mode of bending vibrations having strokes in a direction parallel to said third axis;
whereby said single drive pad becomes capable of providing an actuating action in the direction parallel to said first axis.

53. The electromechanical actuator according to claim 52, wherein said control unit is configured for achieving said first vibration mode by exciting said first, second, third and fourth part volumes with signals having the same frequency; wherein said first and third part volumes are excited in-phase with each other; wherein said second and fourth part volumes are excited in-phase with each other; and wherein said first and second part volumes are excited out-of-phase relative each other.

54. The electromechanical actuator according to claim 52, wherein
said control unit is further configured to provide electrical signals to said set of electrodes causing a second vibration mode of vibrations having strokes with second mode components in a direction of said second axis and other second mode components in a direction of said third axis;
whereby said single drive pad becomes capable of providing an actuating action in a direction of said second axis.

55. The electromechanical actuator according to claim 54, wherein said control unit is configured for achieving said second vibration mode by exciting said first, second, third and fourth part volumes with signals having the same frequency; wherein said first and second part volumes are excited in-phase with each other; wherein said third and fourth part volumes are excited in-phase with each other; and wherein said first and third part volumes are excited out-of-phase relative each other.

56. The electromechanical actuator according to claim 51, wherein said first, second, third and fourth part volumes are bimorph structures of a first respective section and a second respective section of active electromechanically active material attached to each other in said direction of said third axis, wherein said first respective section and a second respective section being excitable independently of each other.

57. The electromechanical actuator according to claim 51, wherein said first, second, third and fourth part volumes are parts of a unimorph structures of a first respective section of active electromechanically active material and a second respective section attached to each other in said direction of said third axis, wherein said second respective section being electromechanically non-excitable.

58. An electromechanical motor, comprising:
a first electromechanical actuator according to claim 51;
a body to be moved, arranged with a drive surface of said body to be moved against said single drive pad;
a normal-force providing means, configured for applying a normal force between said single drive pad and said body to be moved in a direction of said third axis.

59. The electromechanical motor according to claim 58, further comprising a second electromechanical actuator according to claim 1, arranged with said single drive pad of said second electromechanical actuator against said drive surface or against a second drive surface rigidly attached to said body to be moved.

60. The electromechanical motor according to claim 58, wherein said normal-force providing means comprises at least one additional electromechanical actuator according to claim 1.

61. A method for driving an electromechanical actuator, comprising:
exciting a volume of electromechanically active material by providing electrical signals to a set of electrodes provided thereto;
said volume of electromechanically active material having a general rectangular cuboid shape with a first, main, axis that is longer than a second and third axis, mutually perpendicular and both perpendicular to said first axis;
wherein a single drive pad is provided, protruding from said volume of electromechanically active material in a direction parallel to said third axis;
wherein said step of exciting a volume of electromechanically active material comprises exciting of a first, a second, a third and a fourth part volume of said volume of electromechanically active material independently of each other;
wherein said first and second part volumes are situated at a first longitudinal side, along said first axis, with respect to said single drive pad and said third and fourth part volume are situated at a second longitudinal side, opposite to said first longitudinal side, along said first axis, with respect to said single drive pad;
wherein said first and third part volumes are situated at a first transverse side, along said second axis, with respect to said single drive pad and said second and fourth part volumes are situated at a second transverse side, opposite to said first transverse side, along said second axis, with respect to said single drive pad.

62. The method according to claim 61, comprising the further step of:
controlling said electrical signals to said set of electrodes to excite said volume of electromechanically active material in a first vibration mode of bending vibrations having strokes in a direction parallel to said third axis, said first vibration mode causing said single drive pad to provide an actuating action in the direction parallel to said first axis.

63. The method according to 62, wherein said first vibration mode is achieved by exciting said first, second, third and fourth part volumes with signals having the same frequency; wherein said first and third part volumes are excited in-phase with each other; wherein said second and fourth part volumes are excited in-phase with each other; and wherein said first and second part volumes are excited out-of-phase relative each other.

64. The method according to claim 62, comprising the further step of:
controlling said electrical signals to said set of electrodes to excite said volume of electromechanically active material in a second vibration mode of vibrations having strokes with main second mode components in a direction of said second axis and other second mode components in a direction of said third axis, said second vibration mode causing said single drive pad to provide an actuating action in the direction of said second axis.

65. The method according to 64, wherein said second vibration mode is achieved by exciting said first, second, third and fourth part volumes with signals having the same frequency; wherein said first and second part volumes are excited in-phase with each other; wherein said third and fourth part volumes are excited in-phase with each other; and wherein said first and third part volumes are excited out-of-phase relative each other.

66. The method according to claim 61, wherein said exciting of a volume of electromechanically active material is performed by applying electrical fields in the direction of said third axis in said part volumes.

67. The method according to claim 61, wherein said exciting of a volume of electromechanically active material is performed by applying electrical fields in the direction of said second axis in said part volumes.

68. The method according to claim 61, wherein said exciting of a volume of electromechanically active material is performed by applying electrical fields in the direction of said first axis in said part volumes.

69. A method for driving an electromechanical motor, comprising the steps of:
arranging a first electromechanical actuator against a drive surface of a body to be moved;
providing a normal force between a single drive pad of said first electromechanical actuator and said body to be moved;
driving said first electromechanical actuator according to claim 61.

70. The method according to claim 69, comprising the further steps of:
arranging a second electromechanical actuator against said drive surface of said body to be moved or against a second drive surface rigidly attached to said body to be moved;
providing a normal force between a single drive pad of said second electromechanical actuator and said body to be moved;
driving said second electromechanical actuator according to claim 61.
